(19) United States
(12) Patent Application Publication
(10) Pub. No.: US 2023/0223577 A1
(43) Pub. Date: Jul. 13, 2023

(54) SYSTEM OF ASSEMBLING CROSS MEMBER FOR BATTERY CASE

(71) Applicant: SUNGWOO HITECH CO., LTD., Busan (KR)

(72) Inventors: Sung Man Sohn, Yangsan-si (KR); Dong Hyung Choi, Busan (KR)

(21) Appl. No.: 18/079,105

(22) Filed: Dec. 12, 2022

(30) Foreign Application Priority Data
Jan. 7, 2022 (KR) 10-2022-0002598

(51) Int. Cl. H01M 10/04

(52) U.S. Cl. CPC H01M 10/0404

(57) ABSTRACT

Disclosed is a system of assembling a cross member for a battery case. The system of assembling a cross member for a battery case laser-welds a part to be assembled to the cross member with a closed section. The system of assembling a cross member may include: a welding jig configured to clamp the cross member; a core configured to be inserted into the closed section of the cross member clamped to the welding jig; and a core supply jig configured to insert the core into the closed section of the cross member.

### CROSS-REFERENCE TO RELATED APPLICATION

This application claims priority to and the benefit of Korean Patent Application No. 10-2022-0002598 filed in the Korean Intellectual Property Office on Jan. 7, 2022, the entire contents of which are incorporated herein by reference.

### BACKGROUND OF THE INVENTION

### (A) Field of the Invention

The present invention relates to a system of assembling a cross member for a battery case, and more particularly, to a system of assembling a cross member for a battery case, which assembles a cross member mounted on a battery case.

### (B) Description of the Related Art

Recently, the development of electric vehicles has been steadily conducted due to environmental pollution problems and efforts to develop alternative energy.

The electric vehicle is equipped with an electric motor (drive motor) for driving a vehicle and a high voltage battery pack that supplies power to the electric motor. The high voltage battery pack is an energy source that drives the electric motor and supplies the power of high voltage to the electric motor through an inverter.

The battery pack is generally mounted on a lower portion of a vehicle body. The battery pack includes a battery case having an internal space, a plurality of battery modules installed in the internal space of the battery case, and a cover covering the battery case.

Here, a plurality of cross members is mounted on a bottom surface of the battery case, which are configured to partition a mounting region of the plurality of battery modules. For example, each of the plurality of cross members may be formed as a closed cross section having a square cross-sectional shape. Parts to be assembled, such as a case support bracket, a battery module mounting bracket, and a reinforcement bracket are assembled to the plurality of cross members, respectively. The parts to be assembled may be bonded to the plurality of cross members, respectively.

According to the related art, while the parts to be assembled are clamped to a welding jig jointly with the cross member, the parts to be assembled may be bonded to an outer surface of the cross member by a laser beam irradiated by a laser welding gun of a welding robot.

However, according to the related art, since each of the plurality of cross members is formed as the closed cross section having the square cross-sectional shape, when the parts to be assembled are laser-welded to the outer surface, the cross member may be thermally deformed by the laser beam.

The thermal deformation causes a gap between the cross member and the part to be assembled, and as a result, the thermal deformation may act as a cause of reducing a laser welding quality of the part to be assembled for the cross member.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Exemplary embodiments of the present invention have been made to provide a system of assembling a cross member for a battery case, which can minimize thermal deformation of a cross member by a laser beam when parts to be assembled of the cross member are bonded to the cross member by laser welding.

An exemplary embodiment of the present invention provides a system of assembling a cross member for a battery case, which laser-welds a part to be assembled to the cross member with a closed section. The system of assembling a cross member may include: a welding jig configured to clamp the cross member; a core configured to be inserted into the closed section of the cross member clamped to the welding jig; and a core supply jig configured to insert the core into the closed section of the cross member.

The core may include: a first core block which includes a first slip surface formed at one side in a width direction to be inclined in a direction toward the other side; a second core block which includes a second slip surface formed to be inclined at the one side in the width direction to slip on the corresponding first slip surface in an upper and lower direction; a plurality of first magnet members installed on one surface of the first core block; and a plurality of second magnet members installed on one surface of the second core block facing the one surface of the first core block.

The first core block may include a slip member coupled to the one surface and having the first slip surface.

A coupling groove to which the slip member is coupled may be formed on the one surface of the second core block.

Further, the second slip surface may be formed at the coupling groove.

A first pressing surface pressing one surface of the closed section of the cross member may be formed on the other one surface of the first core block.

A second pressing surface pressing the other one surface of the closed section of the cross member may be formed on the other one surface of the second core block.

Each of the plurality of first magnet members may be fitted to the one surface of the first core block and fastened through a first magnet bolt.

Each of the plurality of second magnet members may have a different polarity from each of the plurality of first magnet members and may be fitted to the one surface of the second core block and fastened through a second magnet bolt.

The core may include a first core block and a second core block coupled to each other by a plurality of magnet members, and the first core block and the second core block may be moved away from or close to each other while being slipped in an upper and lower direction through slip surfaces corresponding to each other and formed to be inclined.

Further, the first core block may be located above a top of the second core block, and the core supply jig may insert the core to which the first core block and the second core block are coupled by the plurality of magnet members into the closed section of the cross member.

The welding jig may press the first core block to the lower direction so that the first core block and the second core block are slipped to move away from each other in the upper and lower direction through the inclined slip surfaces while the core is inserted into the closed section of the cross member.

Another exemplary embodiment of the present invention provides a system of assembling a cross member for a battery case, which inserts a core into the cross member with a closed section and laser-welds a part to be assembled to an outer surface of the cross member. The system of assembling a cross member for a battery case may include: a mounting frame installed in a first jig frame; a plurality of first clampers installed in the mounting frame to clamp the part to be assembled which is provisionally coupled to the cross member at both sides of the cross member; at least one second clamper installed in the mounting frame to clamp an upper portion of the cross member; and a core guide unit supporting each of both end portions of the core in a longitudinal direction which is inserted into the closed section of the cross member and installed in the mounting frame to press the core in a lower direction.

The mounting frame may be connected to a motor installed in the first jig frame and rotatably installed in the first jig frame by operation of the motor.

Each core guide unit may include a guide cylinder installed in the mounting frame in an upper and lower direction, a core guide block coupled to a top of an operation rod of the guide cylinder so that the core passes therethrough, at least one core guide roller rotatably installed in the core guide block in a movement direction of the core, and a core pressing unit provided at a top portion of the core guide block and pressing the core in the lower direction.

In one example, the core pressing unit may include a pressing roller rotatably installed at the top portion of the core guide block and connected to the core guide block through a spring.

In the other one example, the core pressing unit may include a pressing plate fixed to the top portion of the core guide block.

The system of assembling a cross member may further include a third clamper installed in the mounting frame to clamp the core pressed by each core guide unit.

The system of assembling a cross member may further include a stopper installed in the mounting frame to be movable in the upper and lower direction to correctly locate the core inserted into the closed section of the cross member.

The system of assembling a cross member may further include a core supply jig installed in a second jig frame and inserting the core into the closed section of the cross member.

The core supply jig may include a core guide member installed in the second jig frame to guide the core in the longitudinal direction, a movement member installed in the second jig frame to reciprocate in the longitudinal direction of the core guide member, and a core clamper installed in the movement member and clamping the core placed on the core guide member.

The core supply jig may further include at least one core alignment member installed in the second jig frame and aligning the core placed on the core guide member.

The at least one core alignment member may include a core alignment cylinder installed in the second jig frame, and a core alignment rod fixed to an end portion of an operation rod of the core alignment cylinder and penetrating a position alignment hole formed in the core.

According to the present invention, when a part to be assembled is bonded to cross members by laser welding, thermal deformation of the cross member by a laser beam can be minimized through a core. Therefore, a gap between the cross member and the part to be assembled can be prevented from being caused, and a laser welding quality of the part to be assembled to the cross member can be further enhanced.

Besides, an effect which can be obtained or predicted by the exemplary embodiment of the present invention is directly or implicitly disclosed in detailed description of the exemplary embodiment of the present invention. That is, various effects predicted according to the exemplary embodiment of the present invention will be disclosed in the detailed description to be described below.

### BRIEF DESCRIPTION OF THE DRAWINGS

These drawings are for the purpose of describing an exemplary embodiment of the present invention, and therefore the technical spirit of the present invention should not be construed as being limited to the accompanying drawings.

FIG. 1 is a perspective view illustrating a system of assembling a cross member for a battery case according to an exemplary embodiment of the present invention.

FIG. 2 is a view illustrating an example of the cross member applied to the system of assembling a cross member for a battery case according to the exemplary embodiment of the present invention.

FIG. 3 is a coupling perspective view illustrating a core applied to the system of assembling a cross member for a battery case according to the exemplary embodiment of the present invention.

FIG. 4 is a partial exploded perspective view illustrating the core applied to the system of assembling a cross member for a battery case according to the exemplary embodiment of the present invention.

FIGS. 5(a) and 5(b) are coupling cross-sectional views illustrating the core applied to the system of assembling a cross member for a battery case according to the exemplary embodiment of the present invention.

FIG. 6 is a perspective view illustrating a welding jig applied to the system of assembling a cross member for a battery case according to the exemplary embodiment of the present invention.

FIG. 7 is a view illustrating a first clamper of the welding jig applied to the system of assembling a cross member for a battery case according to the exemplary embodiment of the present invention.

FIG. 8 is a view illustrating a second clamper of the welding jig applied to the system of assembling a cross member for a battery case according to the exemplary embodiment of the present invention.

FIG. 9 is a view illustrating a stopper of the welding jig applied to the system of assembling a cross member for a battery case according to the exemplary embodiment of the present invention.

FIGS. 10(a) and 10(b) are views illustrating a core guide unit of the welding jig applied to the system of assembling a cross member for a battery case according to the exemplary embodiment of the present invention.

FIG. 11 is a view illustrating a third clamper of the welding jig applied to the system of assembling a cross member for a battery case according to the exemplary embodiment of the present invention.

FIG. 12 is a perspective view illustrating a core supply jig applied to the system of assembling a cross member for a battery case according to the exemplary embodiment of the present invention.

FIG. 13 is a view illustrating a core clamper of the core supply jig applied to the system of assembling a cross member for a battery case according to the exemplary embodiment of the present invention.

FIG. 14 is a view illustrating a core alignment member of the core supply jig applied to the system of assembling a cross member for a battery case according to the exemplary embodiment of the present invention.

It should be understood that the referenced drawings are not particularly illustrated according to a scale, present a brief expression of various preferred features illustrating a basic principle of the present invention. For example, specific design features of the present invention, which include a specific dimension, a specific direction, a specific position, and a specific shape will be partially determined according to a specific intended application and a specific use environment.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various ways, all without departing from the spirit or scope of the present invention.

Terms used herein are used only for a purpose of describing specific exemplary embodiments and are not intended to limit the present disclosure. As used herein, singular forms are also intended to include plural forms unless explicitly displayed in terms of a context.

It should also be understood that the term ‘include’ and/or ‘including’ used herein shows the presence of the specified features, integers, steps, operations, elements and/or components, but it the presence or addition of one or more other features, integers, steps, operations, components, and/or groups thereof is not excluded. As used herein, the term ‘and/or’ include one or all random combinations of one or more items which are associated and listed.

The term ‘coupled’ herein represents a physical relationship between two components directly connected to each other by welding, self piercing rivet (SPR), flow drill screw (FDS), structural adhesive, etc., or indirectly connected through one or more parameters components.

As used here, ‘vehicle’, ‘vehicular’, ‘car’ or other similar terms used herein generally include passenger automobiles including passenger vehicles, sports utility vehicles (SUVs), buses, trucks, and various commercial vehicles, and include hybrid vehicles, electric vehicles, hybrid electric vehicles, electric vehicle-based purpose built vehicle (PBV) vehicles, hydrogen power vehicles and other alternative fuel vehicles (e.g., fuel induced from resources other than petroleum).

Hereinafter, exemplary embodiments of the present invention will be described in detail with reference to the accompanying drawings.

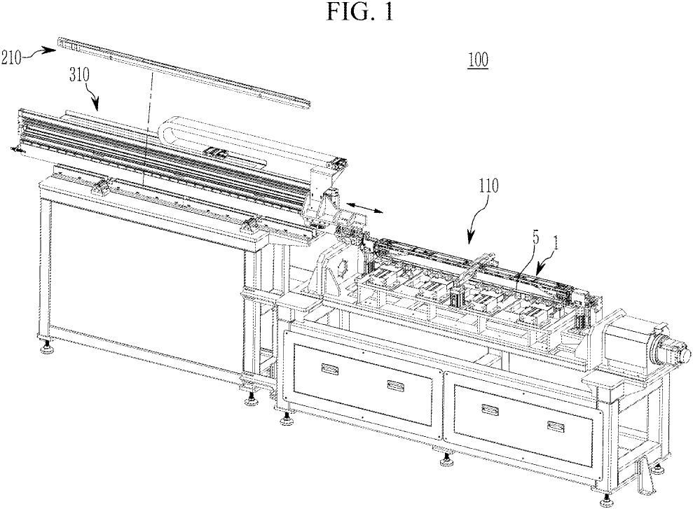

FIG. 1 is a perspective view illustrating a system of assembling a cross member for a battery case according to an exemplary embodiment of the present invention.

Referring to FIG. 1, the system 100 of assembling a cross member for a battery case according to the exemplary embodiment of the present invention may be applied to a process of assembling a battery case (not illustrated) of a battery pack (not illustrated) mounted on an electric vehicle.

Furthermore, the system 100 of assembling a cross member for a battery case according to the exemplary embodiment of the present invention may be applied to a process of assembling a plurality of cross members 1 mounted on the battery case (not illustrated).

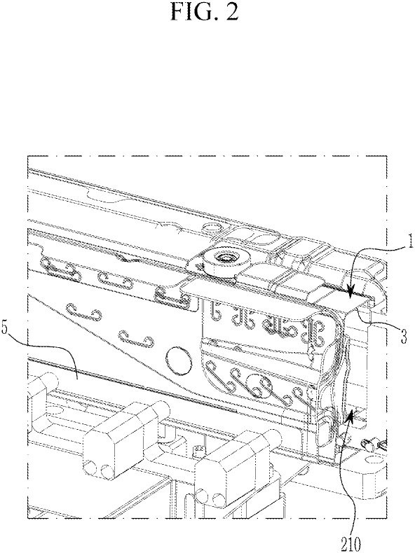

The plurality of cross members 1 is configured to support and fix a plurality of battery modules (not illustrated) stored in the battery case. In one example, each of the plurality of cross members 1 includes a closed section 3 having a substantially square cross-sectional shape as illustrated in FIG. 2.

Here, at least one part 5 to be assembled including a battery module mounting bracket and a reinforcement bracket may be assembled (e.g., bonded or welded) to each of the plurality of cross members 1.

Furthermore, the system 100 of assembling a cross member for a battery case according to the exemplary embodiment of the present invention may be applied to a welding assembly process of laser-welding at least one part 5 to be assembled to each of the plurality of cross members 1 by irradiating a laser beam to a bonding portion of each of the plurality of cross members 1 and at least one part 5 to be assembled.

In one example, the at least one part 5 to be assembled may be a bracket having a “U” cross-sectional shape. The at least one part 5 to be assembled may be bonded to each of the plurality of cross members 1 by laser welding while being provisionally coupled (e.g., fitted) to a lower portion of each of the plurality of cross members 1.

In the exemplary embodiment of the present invention, it is described that the part 5 to be assembled is laser-welded to the cross member 1 mounted on the battery case. However, although not particularly limited thereto, if a part to be assembled such as a bracket is laser-welded to a base material having a closed cross section with a set shape, the technical idea of the present invention may be applied.

In the present invention, an example in which components are mounted will be described based on a front and back direction.

Furthermore, in the present invention, a ‘top portion’, ‘upper portion’, ‘top’ or ‘upper surface’ of the component represents an end portion, portion, end, or surface of the component relatively above in the figure and a bottom portion’, lower portion’, ‘bottom’, or ‘lower surface’ of the component. ‘Lower ends’, ‘lower parts’, ‘bottom’ or ‘lower surface’ represents, an end portion, portion, end, or surface relatively below in the figure.

Furthermore, in the present invention, the end (e.g., one end or the other end) of the component represents the end of the component in a predetermined direction and the end portion (e.g., one end portion or the other end portion) of the component represents a predetermined portion of the component, which includes the end.

The system 100 of assembling a cross member for a battery case according to the exemplary embodiment of the present invention is formed in a structure in which when at least one part 5 to be assembled is bonded to each of the plurality of cross members 1 by laser welding, thermal deformation of the cross members 1 by the laser beam may be minimized.

To this end, the system 100 of assembling a cross member for a battery case according to the exemplary embodiment of the present invention includes a welding jig 110, a core 210, and a core supply jig 310.

In the exemplary embodiment of the present invention, the welding jig 110 laser-welds the part 5 to be assembled to at least one surface (e.g., both surfaces) of the cross member 1.

Furthermore, the welding jig 110 clamps the cross member 1. A configuration of the welding jig 110 will be described below in more detail.

In the exemplary embodiment, the core 210 is insertable into the closed section 3 of the cross member 1 in a longitudinal direction of the cross member 1 clamped to the welding jig 110.

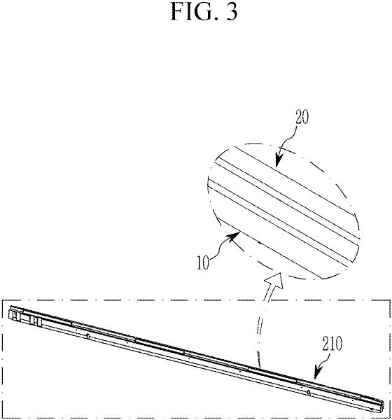

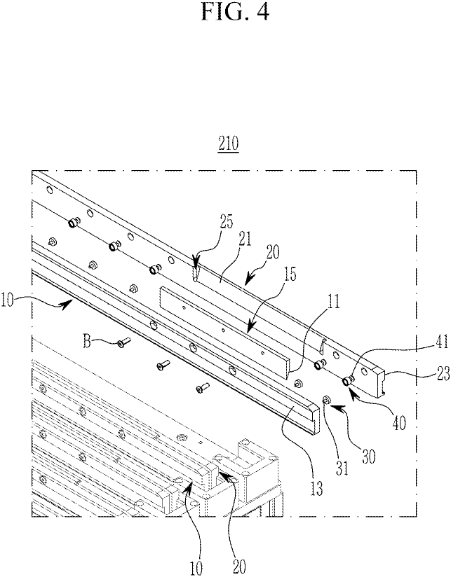

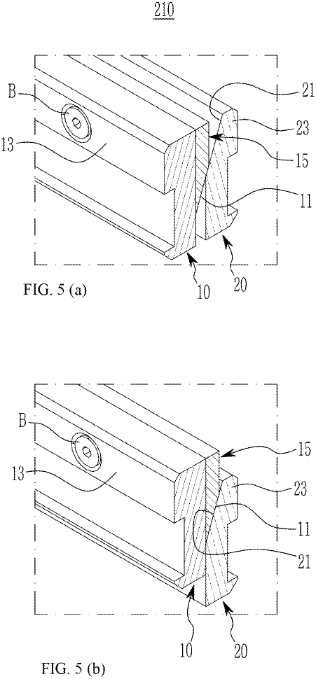

FIG. 3 is a coupling perspective view illustrating a core applied to the system of assembling a cross member for a battery case according to the exemplary embodiment of the present invention, FIG. 4 is a partial exploded perspective view illustrating the core applied to the system of assembling a cross member for a battery case according to the exemplary embodiment of the present invention, and FIGS. 5 is a coupling cross-sectional view illustrating the core applied to the system of assembling a cross member for a battery case according to the exemplary embodiment of the present invention.

Referring to FIGS. 1 to 5, the core 210 according to the exemplary embodiment of the present invention basically includes a first core block 10, a second core block 20, a plurality of first magnet members 30, and a plurality of second magnet members 40.

The first core block 10 is made of a steel material. The first core block 10 includes a slip surface 11 formed to be inclined to the other one side at one side in a width direction.

A first pressing surface 13 pressing one surface of an inside (e.g., the closed section 3) of each of the plurality of cross members 1 is formed on the other surface of the first core block 10.

Furthermore, the first core block 10 further includes a slip member 15 coupled to the one surface. The slip member 15 is formed on the first slip surface 11 mentioned above in an upper and lower direction.

Here, the slip member 15 is fastened to one surface of the first core block 10 through a plurality of bolts B.

The second core block 20 is made of the steel material. The second core block 20 includes a second slip surface 21 formed to be inclined at one side in the width direction to slip on the first slip surface 11 of the corresponding first core block 10 in the upper and lower direction.

A second pressing surface 23 pressing the other one surface of the inside (e.g., the closed section 3) of each of the plurality of cross members 1 is formed on the other one surface of the second core block 20.

A coupling groove 25 to which a slip member 15 is capable of being coupled is formed on one surface of the second core block 20 to slip on the first slip surface 11 of the first core block 10 in the upper and lower direction.

Here, a second slip surface 21 which is enabled to slip on the first slip surface 11 of the slip member 15 in the upper and lower direction is formed at the coupling groove 25.

The plurality of first magnet members 30 and the plurality of second magnet members 40 couple surfaces of the first core block 10 and the second core block, which face each other.

Each of the plurality of first magnet member 30 is installed on one surface of the first core block 10. Each of the plurality of first magnet members 30 may be fitted to one surface of the first core block 10 and fastened to one surface of the first core block 10 through a first magnet bolt 31.

In addition, each of the plurality of second magnet member 40 is installed on one surface of the second core block 20, which faces one surface of the first core block 10. Each of the plurality of second magnet members 40 may show a different polarity from each of the plurality of first magnet members 30. Each of the plurality of second magnet members 40 may be fitted to one surface of the second core block 20 and fastened to one surface of the second core block 20 through a second magnet bolt 41.

Here, each of the plurality first magnet members 30 installed on one surface of the first core block 10 and each of the plurality of second magnet members 40 installed on one surface of the second core block 20 may be arranged to be spaced apart from each other in the upper and lower direction.

Furthermore, the first core block 10 and the second core block 20 may be moved away from or closer to each other while being slipped in the upper and lower direction through the first slip surface 11 and the second slip surface 21 facing and contacting each other, respectively.

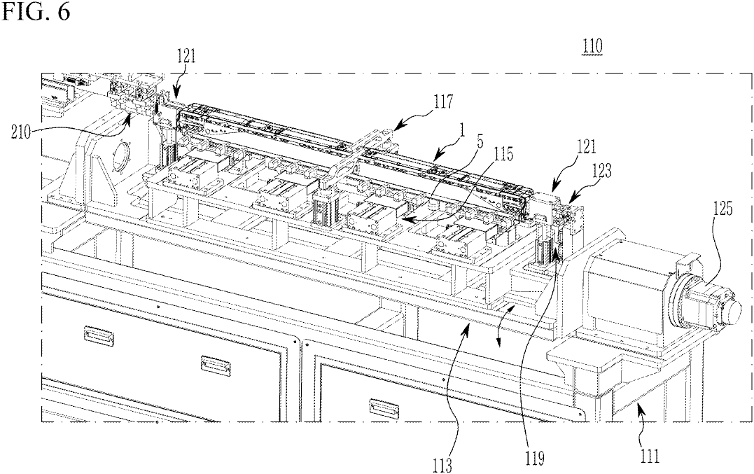

FIG. 6 is a perspective view illustrating a welding jig applied to the system of assembling a cross member for a battery case according to the exemplary embodiment of the present invention.

Referring to FIG. 6, the welding jig 110 according to the exemplary embodiment of the present invention includes a first jig frame 111, a mounting frame 113, a plurality of first clampers 115, at least one second clamper 117, a stopper 119, a core guide unit 121, and a third clamper 123.

The first jig frame 111 is installed on a floor surface of a process work site. The first jig frame 111 is configured to mount various components to be described below. The first jig frame 111 may be constituted by one frame or two or more partitioned frames.

The first jig frame 111 may include various accessory elements such as a bracket, a bar, a rod, a plate, a housing, a case, a block, a partition, and a rib configured to support respective components.

However, since the various accessory elements are configured to mount the respective components to be described below on the first jig frame 111, the various accessory elements are collectively referred to as the first jig frame 111 except for an exceptional case in the exemplary embodiment of the present invention.

The mounting frame 113 is installed in the first jig frame 111. Furthermore, the mounting frame 113 may be rotatably installed in the first jig frame 111 so as to smoothly perform the laser welding.

Therefore, the mounting frame 113 is operatively connected to a motor 125 installed in the first jig frame 111. The mounting frame 113 may be rotated by driving the motor 125.

The plurality of first clampers 115 clamps the part 5 to be assembled to which the cross member 1 is provisionally coupled at both sides of the cross member 1. The plurality of first clampers 115 is installed in the mounting frame 113.

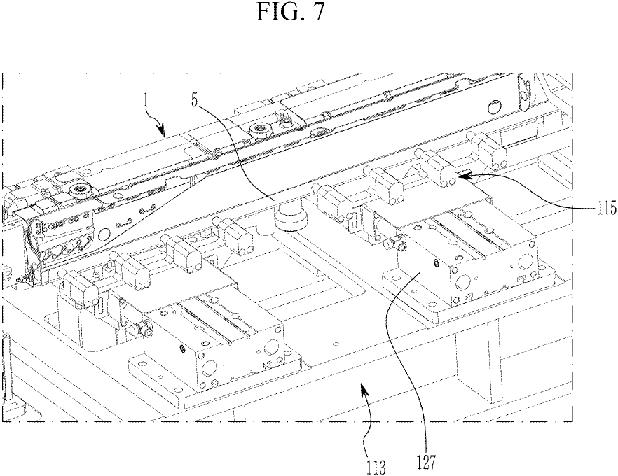

Here, each of the plurality of first clampers 115 is operatively connected to the first clamp cylinder 127 as illustrated in FIG. 7. Each of the plurality of first clampers 115 may move forward or backward by operating the first clamp cylinder 127 and clamp the part 5 to be assembled at both sides of the cross member 1.

The at least one second clamper 117 is configured to clamp the upper portion of the cross member 1 at both sides of the cross member 1. The at least one second clamper 117 is installed on the mounting frame 113.

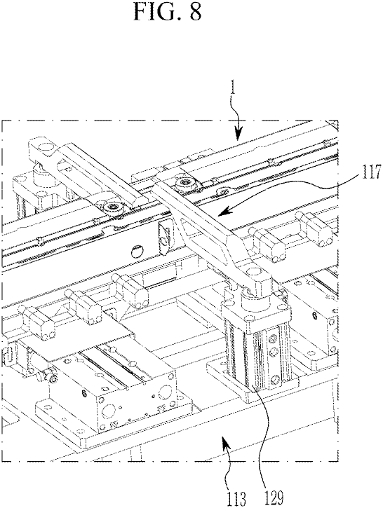

The at least one second clamper 117 is operatively connected to the second clamp cylinder 129 as illustrated in FIG. 8. The at least one second clamper 117 may move forward or backward by operating the second clamp cylinder 129 and clamp the upper portion of the cross member 1.

The stopper 119 correctly locates the core 210 inserted into the closed section 3 of the cross member 1. The stopper 119 is installed in the mounting frame 113 to be movable in the upper and lower direction.

Here, the stopper 119 is operatively connected to a stopper cylinder 131 installed in the mounting frame 113 in the upper and lower direction. The stopper 119 may be moved in the upper and lower direction by operating the stopper cylinder 131 and may stop the end portion of the inserted into the closed section 3 of the cross member 1.

The core guide unit 121 supports each of both end portions of the core 210 inserted into the closed section 3 of the cross member 1 and presses the core 210 in a lower direction.

Here, the core 210 inserted into the closed section 3 of the cross member 1 is in a state in which the first core block 10 is located above the top of the second core block 20, and the first core block 10 and the second core block 20 are coupled by the plurality of first magnet members 30 and the plurality of second magnet members 40, as illustrated in FIGS. 3 to 5. That is, the first slip surface 11 of the first core block 10 is located at an upper portion of the second slip surface 21 of the second core block 20.

The core guide units 121 are installed in the mounting frame to correspond to both end portions, respectively in the longitudinal direction of the cross member 1 clamped to the plurality of first clampers 115 and at least one second clamper 117.

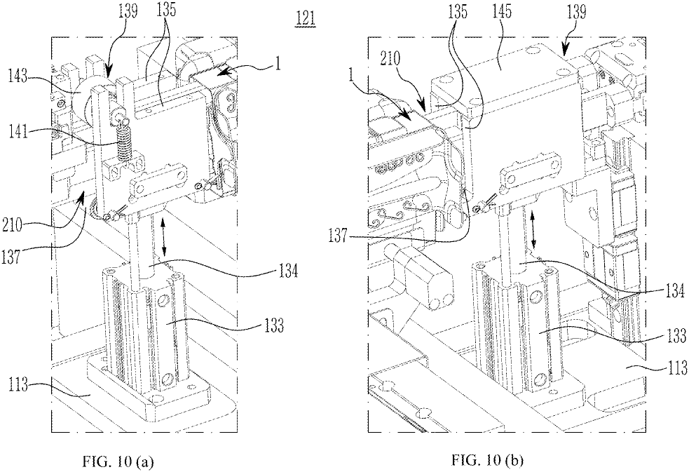

Each core guide unit 121 includes a guide cylinder 133, a core guide block 135, at least one core guide roller 137, and a core pressing unit 139 as illustrated in FIGS. 10.

The guide cylinders 133 are installed in the mounting frame 113 in the upper and lower direction to correspond to both end portions of the core 210 inserted into the closed section 3 of the cross member 1.

The core guide block 135 is operatively connected to the top of an operation rod of the guide cylinder 133 so that the core 210 passes.

The at least one core guide block 137 is rotatably installed in the core guide block 135 in a movement direction of the core 210 so as to support both end portions of the core 210.

In addition, the core pressing unit 139 presses the core 210 in the lower direction through the core guide block 135 by a backward operation of the guide cylinder 133. The core pressing unit 139 is provided on a top portion of the core guide block 135.

The core pressing unit 139 may be rotatably installed on the top portion of the core guide block 135 and include a pressing roller 143 connected to the core guide block 135 through a spring 141, in one example. In the other one example, the core pressing unit 139 may include a pressing plate 145 fixed to the top portion of the core guide block 135.

Here, when the core 210 inserted into the closed section 3 of the cross member 1 is pressed in the lower direction through the core pressing unit 139 by the backward operation of the guide cylinder 13, the first core block 10 and the second core block 120 may be moved away from each other while being slipped in the upper and lower direction through the first slip surface 11 and the second slip surface 21.

In addition, the third clamper 123 is configured to clamp the core 210 pressed by the core pressing unit 139 of each core guide unit 121. The third clamper 123 is installed in the mounting frame 113.

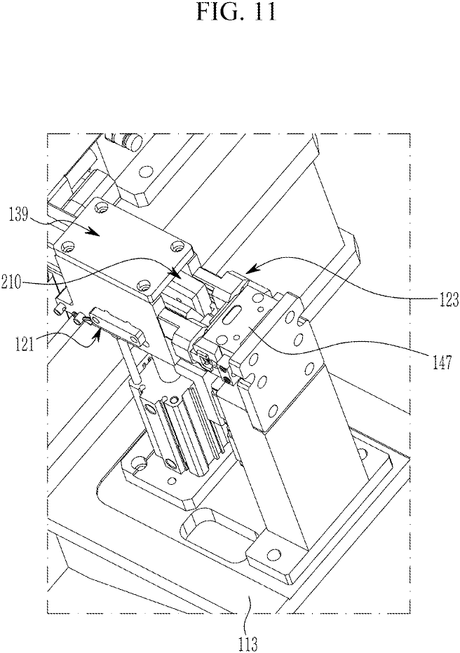

The third clamper 123 is operatively connected to a third clamp cylinder 147 installed in the mounting frame 113 as illustrated in FIG. 11.

The third clamper 123 may be moved by operating the third clamp cylinder 147, and may clamp the end portion of the core 210

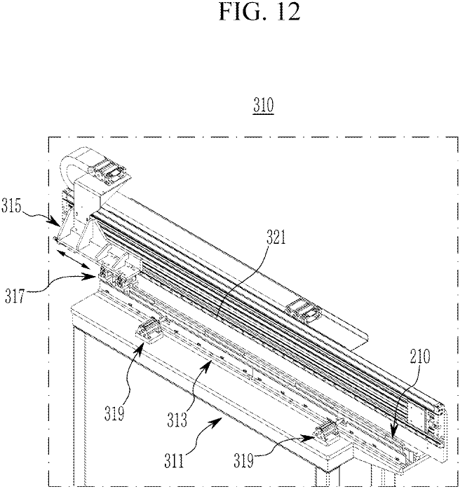

FIG. 12 is a perspective view illustrating a core supply jig applied to the system of assembling a cross member for a battery case according to the exemplary embodiment of the present invention.

Referring to FIGS. 6 and 12, the core supply jig 310 according to the exemplary embodiment of the present invention inserts the core 210 into the closed section 3 of the cross member 1 clamped by the welding jig 110.

Here, as illustrated in FIGS. 3 to 5, the first core block 10 may be located above the top of the second core block 20, and the core supply jig 310 may insert the core 210 to which the first core block 10 and the second core block 20 are coupled into the closed section 3 of the cross member 1 by the plurality of first magnet members 30 and the plurality of second magnet members 40.

The core supply jig 310 includes a second jig frame 311, a core guide member 313, a movement member 315, a core clamper 317, and at least one core alignment member 319.

The second jig frame 311 is installed on the floor surface of the process work site and disposed close to the first jig frame 111 of the welding jig 110. The second jig frame 311 is configured to mount various components to be described below. The second jig frame 311 may be constituted by one frame or two or more partitioned frames.

The second jig frame 311 may include various accessory elements such as the bracket, the bar, the rod, the plate, the housing, the case, the block, the partition, and the rib configured to support respective components.

However, since the various accessory elements are configured to mount the respective components to be described below on the second jig frame 311, the various accessory elements are collectively referred to as the second jig frame 311 except for an exceptional case in the exemplary embodiment of the present invention.

The core guide member 313 is installed in the second jig frame 311 to guide the core 210 in the longitudinal direction. The core guide member 313 is disposed on the same line as the closed section 3 of the cross member 1 clamped to the welding jig 110.

The movement member 315 is installed in the second jig frame 311 to reciprocate in the longitudinal direction of the core guide member 313. The movement member 315 may reciprocate in the longitudinal direction of the core guide member 313 by a driving device (e.g., a servo motor, a lead screw or a ball screw, and a guide rail structure) well known to those skilled in the art. The movement member 315 may be slidably coupled to a rail 312 disposed in the second jig frame 311 in the longitudinal direction of the core guide member 313.

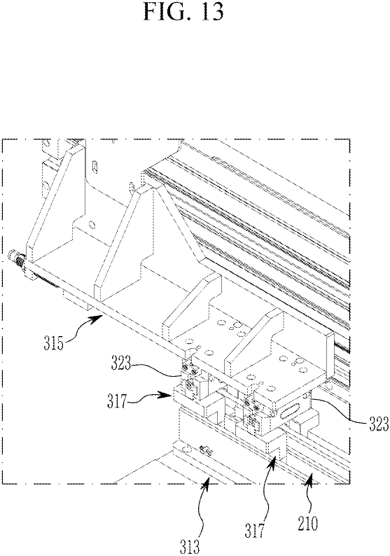

The core clamper 317 clamps the end portion of the core 210 placed in the core guide member 313. The core clamper 317 is installed in the movement member 315. The core clamper 317 is operatively connected to a gripper cylinder 323 installed in the movement member 315 as illustrated in FIG. 13. The core clamper 317 may clamp (e.g., grip) the end portion of the core 210 by operating the gripper cylinder 323.

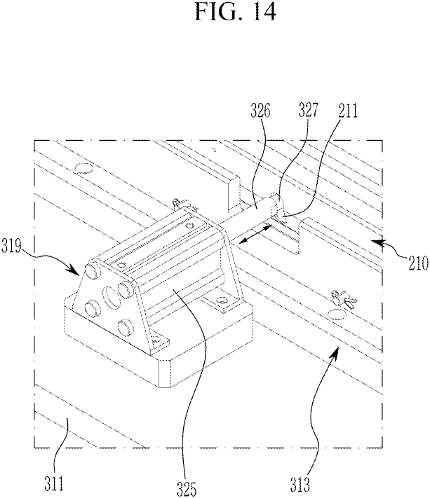

In addition, the at least one core alignment member 319 aligns (e.g., correctly locates) the core 210 placed in the core guide member 313. The at least one core alignment member 319 is installed in the second jig frame 311. The at least one core alignment member 319 includes a core alignment cylinder 325 and a core alignment rod 327 as illustrated in FIG. 14.

The core alignment cylinder 325 is installed in the second jig frame 311. The core alignment rod 327 is fixed to the end portion of an operation rod 326 of the core alignment cylinder 325. The core alignment rod 327 may penetrate a position alignment hole 211 formed in the core 210. Here, the position alignment hole 211 may be formed in the core 210 in a long hole form in the upper and lower direction.

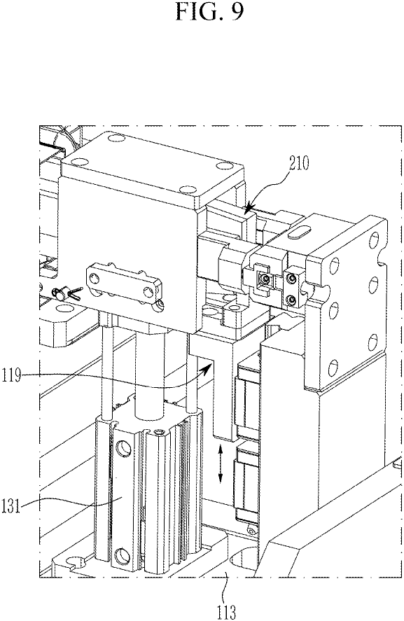

Hereinafter, an action of the system 100 of assembling the cross member for the battery case according to the exemplary embodiment of the present invention configured as such will be described in detail with reference to FIGS. 1 to 14.

First, in the exemplary embodiment of the present invention, the cross member 1 is placed in the mounting frame 113 of the welding jig 110, and the part 5 to be assembled to which the cross member 1 is provisionally coupled is clamped through the plurality of first clampers 115 at both sides of the cross member 1.

Next, in the exemplary embodiment of the present invention, the upper portion of the cross member 1 is clamped through at least one second clamper 117 at both sides of the cross member 1.

Here, the core guide block 135 of the core guide unit 121 is in a state of moving in the upper direction jointly with the core pressing unit 139 by operating the guide cylinder 133. In addition, the core alignment rod 327 of at least one core alignment member 319 is in a state of moving backward by the backward operation of the core alignment cylinder 325. Furthermore, the movement member 315 is in a state of moving backward jointly with the core clamper 317 by driving of a driving device (not illustrated).

Then, in the exemplary embodiment of the present invention, the core 210 is placed on the core guide member 313 of the core supply jig 310, and the core alignment rod 327 is moved forward by a forward operation of the core alignment cylinder 325. As a result, the core alignment rod 327 correctly locates the core 210 at the core guide member 313 while being fitted to the alignment hole 211 of the core 210.

In this case, the core 210 is in a state in which the first core block 10 is located above the top of the second core block 20, and the first core block 10 and the second core block 20 are coupled by the plurality of first magnet members 30 and the plurality of second magnet members 40.

Next, in the exemplary embodiment of the present invention, the end portion of the core 210 is clamped through the core clamp 317 and the core alignment rod 327 is moved backward by the backward operation of the core alignment cylinder 325. Therefore, the core alignment rod 327 is extracted from the position alignment hole 211 of the core 210. In this case, the stopper 119 is in a state of moving in the upper direction by operating the stopper cylinder 131.

Next, in the exemplary embodiment of the present invention, the movement member 315 is moved forward by driving the driving device (not illustrated). Then, the core 210 is transported along the core guide member 313 by the movement member 315 and inserted into the closed section 3 of the cross member 1 on the welding jig 110 while being clamped to the core clamper 317.

Here, both end portions of the core 210 penetrate the core guide block 135 of the core guide unit 121 and located inside the core guide block 135 while moving through at least one core guide roller 137. In this case, the end portion of the core 210 does not move forward any longer while being sopped by the stopper 119.

Then, in the exemplary embodiment of the present invention, clamping the end portion of the core 210 is released by an unclamping operation of the core clamper 317, and the core guide block 135 is moved in the lower direction by the backward operation of the guide cylinder 133.

As a result, the core pressing unit 139 of the core guide unit 121 presses the core 210 in the lower direction through the core guide block 135. Then, the cores 210 are moved away from each other in the closed section 3 of the cross member 1 while being slipped in the upper and lower direction through the first slip surface 11 and the second slip surface 21 of the first core block 10 and the second core block 20.

As the first core block 10 and the second core block 20 are moved away from each other as described above, the first pressing surface 13 of the first core block 10 presses one surface in the closed section 3 of the cross member 1 and the second pressing surface 23 of the second core block 20 presses the other one surface in the closed section 3 of the cross member 1.

Thereafter, in the exemplary embodiment of the present invention, the core 210 pressed by the core pressing unit 139 is clamped through the third clamper 123.

In such a state, in the exemplary embodiment of the present invention, when the laser beam is irradiated to the bonding portion of the part 5 to be assembled through the laser welding gun (not illustrated) of the welding robot (not illustrated), the part 5 to be assembled may be laser-welded to both surfaces of the cross member 1.

Here, in the exemplary embodiment of the present invention, while the mounting frame 113 is rotated by driving the motor 125 so that the laser welding gun does not interfere with parts of the welding jig 110, the laser beam is irradiated through the laser welding gun and the part 5 to be assembled may be laser-welded to both surfaces of the cross member 1.

By the system 100 of assembling the cross member for the battery case according to the exemplary embodiment of the present invention described up to now, the core 210 may be automatically inserted into the closed section 3 of the cross member 1 and both surfaces inside the closed section 3 of the cross member 1 may be pressed through the core 210.

Accordingly, in the exemplary embodiment of the present invention, when part 5 to be assembled is bonded to the cross members 1 by the laser welding, the thermal deformation of the cross member 1 by the laser beam may be minimized through the core 210.

As a result, in the exemplary embodiment of the present invention, a gap between the cross member 1 and the part 5 to be assembled can be prevented from being caused, and a laser welding quality of the part 5 to be assembled to the cross member 1 can be further enhanced.

Although the preferred implementation examples, the examples, and the implementation examples of the present invention are described through the above description, but the present invention is not limited thereto and various modifications can be made within the claims and the range of the detailed description and the accompanying drawings of the invention, and this also belongs to the scope of the present invention, of course.

Description of Symbols

| | | | |
|---|---|---|---|
| 1 | Cross member | 3 | Closed section |
| 7 | Part to be assembled | 5 | Part to be assembled |
| B | Bolt | 10 | First core block |
| 11 | First slip surface | 13 | First pressing surface |
| 15 | Slip member | 20 | Second core block |
| 21 | Second slip surface | 23 | Second pressing surface |
| 25 | Coupling groove | 30 | 30: First magnet member |
| 31 | First magnet bolt | 40 | 40: Second magnet member |
| 41 | Second magnet bolt | | |
| 100 | Cross member assembling system | | |
| 110 | Welding jig | 111 | First jig frame |
| 113 | Mounting frame | 115 | First clamper |
| 117 | Second clamper | 119 | Stopper |
| 121 | Core guide unit | 123 | Third clamper |
| 125 | Motor | 127 | First clamp cylinder |
| 129 | Second clamp cylinder | 131 | Stopper cylinder |
| 133 | Guide cylinder | 134, 326 | Operation rod |
| 135 | Core guide block | 137 | Core guide roller |
| 139 | Core pressing unit | 141 | Spring |
| 143 | Pressing roller | 145 | Pressing plate |
| 147 | Third clamp cylinder | 210 | Core |
| 211 | Position alignment hole | 310 | Core supply jig |
| 311 | Second jig frame | 313 | Core guide member |
| 315 | Movement member | 317 | Core clamper |
| 219 | Core alignment member | 321 | Rail |
| 323 | Gripper cylinder | 325 | Core alignment cylinder |
| 327 | Core alignment rod | | |

What is claimed is:

1. A system of assembling a cross member for a battery case, which laser-welds a part to be assembled to the cross member with a closed section, the system comprising:
a welding jig configured to clamp the cross member;
a core configured to be inserted into the closed section of the cross member clamped to the welding jig; and
a core supply jig configured to insert the core into the closed section of the cross member.

2. The system of claim 1, wherein the core includes:
a first core block including a first slip surface formed at one side in a width direction to be inclined in a direction toward the other side,
a second core block including a second slip surface formed to be inclined at the one side in the width direction to slip on the corresponding first slip surface in an upper and lower direction,
a plurality of first magnet members installed on one surface of the first core block, and
a plurality of second magnet members installed on one surface of the second core block facing the one surface of the first core block.

3. The system of claim 2, wherein:
the first core block includes a slip member coupled to the one surface and having the first slip surface.

4. The system of claim 3, wherein:
a coupling groove to which the slip member is coupled is formed on the one surface of the second core block, and
the second slip surface is formed at the coupling groove.

5. The system of claim 2, wherein:
a first pressing surface pressing one surface of the closed section of the cross member is formed on the other one surface of the first core block, and
a second pressing surface pressing the other one surface of the closed section of the cross member is formed on the other one surface of the second core block.

6. The system of claim 2, wherein:
each of the plurality of first magnet members is fitted to the one surface of the first core block and fastened through a first magnet bolt, and
each of the plurality of second magnet members has a different polarity from each of the plurality of first magnet members and is fitted to the one surface of the second core block and fastened through a second magnet bolt.

7. The system of claim 1, wherein:
the core includes a first core block and a second core block coupled to each other by a plurality of magnet members, and
the first core block and the second core block are moved away from or close to each other while being slipped in an upper and lower direction through slip surfaces corresponding to each other and formed to be inclined.

8. The system of claim 7, wherein:
the first core block is located above a top of the second core block, and the core supply jig inserts the core to which the first core block and the second core block are coupled by the plurality of magnet members into the closed section of the cross member.

9. The system of claim 8, wherein:
the welding jig presses the first core block to the lower direction so that the first core block and the second core block are slipped to move away from each other in the upper and lower direction through the inclined slip surfaces while the core is inserted into the closed section of the cross member.

10. A system of assembling a cross member for a battery case, which inserts a core into the cross member with a closed section and laser-welds a part to be assembled to an outer surface of the cross member, the system comprising:
a mounting frame installed in a first jig frame;
a plurality of first clampers installed in the mounting frame to clamp the part to be assembled which is provisionally coupled to the cross member at both sides of the cross member;
at least one second clamper installed in the mounting frame to clamp an upper portion of the cross member; and
a core guide unit supporting each of both end portions of the core in a longitudinal direction which is inserted into the closed section of the cross member and installed in the mounting frame to press the core in a lower direction.

11. The system of claim 10, wherein:
the mounting frame is connected to a motor installed in the first jig frame and rotatably installed in the first jig frame by operation of the motor.

12. The system of claim 10, wherein each core guide unit includes:
a guide cylinder installed in the mounting frame in an upper and lower direction,
a core guide block coupled to a top of an operation rod of the guide cylinder so that the core passes therethrough,
at least one core guide roller rotatably installed in the core guide block in a movement direction of the core, and
a core pressing unit provided at a top portion of the core guide block and pressing the core in the lower direction.

13. The system of claim 12, wherein:
the core pressing unit includes a pressing roller rotatably installed at the top portion of the core guide block and connected to the core guide block through a spring.

14. The system of claim 12, wherein:
the core pressing unit includes a pressing plate fixed to the top portion of the core guide block.

15. The system of claim 10, further comprising:
a third clamper installed in the mounting frame to clamp the core pressed by each core guide unit.

16. The system of claim 10, further comprising:
a stopper installed in the mounting frame to be movable in the upper and lower direction to correctly locate the core inserted into the closed section of the cross member.

17. The system of claim 10, further comprising:
a core supply jig installed in a second jig frame and inserting the core into the closed section of the cross member.

18. The system of claim 17, wherein the core supply jig includes:
a core guide member installed in the second jig frame to guide the core in the longitudinal direction,
a movement member installed in the second jig frame to reciprocate in the longitudinal direction of the core guide member, and
a core clamper installed in the movement member and clamping the core placed on the core guide member.

19. The system of claim 18, wherein:
the core supply jig further includes at least one core alignment member installed in the second jig frame and aligning the core placed on the core guide member.

20. The system of claim 19, wherein the at least one core alignment member includes:
a core alignment cylinder installed in the second jig frame, and
a core alignment rod fixed to an end portion of an operation rod of the core alignment cylinder and penetrating a position alignment hole formed in the core.
